(19) United States
(12) Patent Application Publication
(10) Pub. No.: US 2025/0280270 A1
(43) Pub. Date: Sep. 4, 2025

(54) DATA SHARING AMONG CLIENT DEVICES

(71) Applicant: Connectify, Inc., Philadelphia, PA (US)

(72) Inventors: Kevin Cunningham, Swarthmore, PA (US); Brian Prodoehl, Plymouth Meeting, PA (US); Alexander Gizis, Philadelphia, PA (US)

(21) Appl. No.: 19/064,563

(22) Filed: Feb. 26, 2025

Related U.S. Application Data
(60) Provisional application No. 63/559,830, filed on Feb. 29, 2024.

(51) Int. Cl. H04W 4/16; H04L 12/46

(52) U.S. Cl. CPC H04W 4/16; H04L 12/4641

(57) ABSTRACT

One example may include communicating, via a mobile device, with a router of a Wi-Fi network and a base station of a cellular network, identifying, via the mobile device, another mobile device operating on the Wi-Fi network, transmitting, via the mobile device, a request for data to the another mobile device, and the request is transmitted to the router, and responsive to the request being approved by the another mobile device, receiving, via the mobile device, data from the another mobile device.

### TECHNICAL FIELD

This application relates to data sharing and more particularly data sharing among various client devices operating on neighboring and/or same networks.

### BACKGROUND

Client devices may be identified as being at a particular source and location and having specific attributes, such as a hardware device profile, an assigned IP address, an assigned network, etc. The use of client devices to perform various data access operations can be prohibited or at least limited by the settings and restrictions of the remote sources that are being accessed by the client devices. For example, a client device may be attempting to access a secure and popular server for secure information, such as streaming content, secure order information, access to a protected account, etc.

A virtual private network (VPN) server is a tool that can offer an alternative to a client device's normal network data traffic. Generally, a VPN server may use different network routes and perform encryption among other data management operations. When client devices desire to share data and related services with other client devices, the VPN server may provide a way to connect to the Internet and remote servers to download data and forward the data to one or more requesting client devices. One or more client devices may provide data sharing with one or more other client devices by receiving the shared data through the VPN server.

### SUMMARY

One example embodiment may include communicating, via a mobile device, with one or more of a Wi-Fi network and a cellular network, identifying, via the mobile device, another mobile device operating on another Wi-Fi network different from the Wi-Fi network, transmitting, via the mobile device, a request for data to the another mobile device, and responsive to the request being approved by the another mobile device, receiving, via the mobile device, data from the another Wi-Fi network directly from the another mobile device.

Another example embodiment may include communicating, via a mobile device, with a router of a Wi-Fi network and a base station of a cellular network, identifying, via the mobile device, another mobile device operating on the Wi-Fi network, transmitting, via the mobile device, a request for data to the another mobile device, and the request is transmitted to the router, and responsive to the request being approved by the another mobile device, receiving, via the mobile device, data from the another mobile device.

### BRIEF DESCRIPTION OF THE DRAWINGS

FIG. 1 illustrates a communication network used to support data management of client devices according to example embodiments.

FIG. 2 illustrates an example of client devices sharing data across different Wi-Fi data networks according to example embodiments.

FIG. 3A illustrates an example of client devices sharing data across a router of a local area network according to example embodiments.

FIG. 3B illustrates an example of client devices sharing data across a router of a local area network in close proximity according to example embodiments.

FIG. 3C illustrates an example of client devices sharing data directly when not in proximity to a router according to example embodiments.

FIG. 4A is a process according to example embodiments.

FIG. 4B is a process according to example embodiments.

FIG. 5 illustrates a system configuration for storing and executing instructions for any of the example processes according to example embodiments.

### DETAILED DESCRIPTION

It will be readily understood that the components of the present application, as generally described and illustrated in the figures herein, may be arranged and designed in a wide variety of different configurations. Thus, the following detailed description of the embodiments of a method, apparatus, and system, as represented in the attached figures, is not intended to limit the scope of the application as claimed, but is merely representative of selected embodiments of the application.

The features, structures, or characteristics of the application described throughout this specification may be combined in any suitable manner in one or more embodiments. For example, the usage of the phrases “example embodiments”, “some embodiments”, or other similar language, throughout this specification refers to the fact that a particular feature, structure, or characteristic described in connection with the embodiment may be included in at least one embodiment of the present application. Thus, appearances of the phrases “example embodiments”, “in some embodiments”, “in other embodiments”, or other similar language, throughout this specification do not necessarily all refer to the same group of embodiments, and the described features, structures, or characteristics may be combined in any suitable manner in one or more embodiments.

In addition, while the term “message” has been used in the description of embodiments of the present application, the application may be applied to many types of network data, such as, packet, frame, datagram, etc. For purposes of this application, the term “message” also includes packet, frame, datagram, and any equivalents thereof. Furthermore, while certain types of messages and signaling are depicted in exemplary embodiments of the application, the application is not limited to a certain type of message, and the application is not limited to a certain type of signaling.

Example embodiments provide data management services for client devices participating in a shared data network configuration. Data may be sent and received to and from a remote network and shared between the devices to provide a larger data rate, a more reliable data service and an optimized data connection.

Example embodiments may be referred to with reference to a communication ‘session’. The term ‘session’ may be a communication data link between a ‘client’ (computing device, smartphone, computer, etc.) and ‘server’ (content server, virtual private network server, destination server, etc.) or any two or more network-based entities in communication across a data communication network. A session may be based on a single communication link or channel or multiple links or channels. Examples of multiple channels being used in a session may be based on multiple network interface devices (i.e., network interface cards (NICs)) being used in a single session, and/or multiple TCP/UDP sockets being created in a single session among other device resources. Multiple transport connections which are established via TCP and/or UDP may also be considered a session. Additionally, encryption that is used for the session may be independently established to include a unique key for each transport connection and/or channel established for the session. The session encryption may instead be a single key encryption used to encrypt all the communication exchanges during the session. In general, most transport connections are encrypted independently. All of the described examples of a session may be adapted to include one or more alternatives or combinations thereof. Each session may be subjected to multiple different communication mediums providing a variety of one or more channels, transports, radio links, physical links, network interface cards and wireless and/or wired connections.

Network connection optimization for an application server provides data network access through communication channels to one or more client devices. Data communication protocols may include one or more of a transmission control protocol (TCP) and/or a user datagram protocol (UDP). Also, the TCP/IP protocol suite enables the determination of how a specific device should be connected to the Internet and how data can be exchanged by enabling a virtual network when multiple network devices are connected. TCP/IP stands for transmission control protocol/Internet protocol and it is specifically designed as a model to offer reliable data byte streams over various interconnected data networks.

UDP is a datagram/packet oriented protocol used for broadcast and multicast types of network transmissions. The UDP protocol may work similar to TCP, but with some of the error-checking criteria removed which reduces the amount of back-and-forth communication and deliverability requirements.

TCP is a connection-oriented protocol and UDP is a connectionless protocol. The speeds (data rates) associated with TCP are generally slower than UDP, while the speed of UDP is generally faster within the network with regard to sending data across a network. TCP uses a ‘handshake’ protocol such as ‘SYN’, ‘SYN-ACK’, ‘ACK’, etc., while UDP uses no handshake protocols. TCP performs error checking and error recovery, and UDP performs error checking, but discards erroneous packets. TCP employs acknowledgment segments, but UDP does not have any acknowledgment segment.

A TCP connection is established with a three-way handshake, which is a process of initiating and acknowledging a connection. Once the connection is established, data transfer begins and when the transmission process is finished the connection is terminated by the closing of an established virtual circuit. UDP uses a simple transmission approach without implied hand-shaking requirements for ordering, reliability, or data integrity. UDP also disregards error checking and correction efforts to avoid the overhead of such processing efforts at the network interface level, and is also compatible with packet broadcasts and multicasting.

TCP reads data as streams of bytes, and the message is transmitted to segment boundaries. UDP messages contain packets that were sent one by one. It also checks for integrity at the arrival time. TCP messages move across the Internet from one computer to another. It is not connection-based, so one program can send lots of packets to another. TCP rearranges data packets in a specific order. UDP protocol has no fixed order because all the packets are independent of each other. The speed for TCP is slower and UDP is faster since error recovery is omitted from UDP. The header sizes are 20 bytes and 8 bytes for TCP and UDP, respectively.

In general, TCP requires three packets to set up a socket connection before any user data can be sent. UDP does not require three packets for socket setup. TCP performs error checking and also error recovery and UDP performs error checking, but discards erroneous packets. TCP is reliable as it guarantees delivery of data to the destination router. The delivery of data to the destination is not guaranteed by UDP. UDP is ideal to use with multimedia such as voice over IP (VOIP) since minimizing delays is critical. TCP sockets should be used when both the client and the server independently send packets and an occasional delay is acceptable. UDP should be used if both the client and the server separately send packets, and an occasional delay is not acceptable.

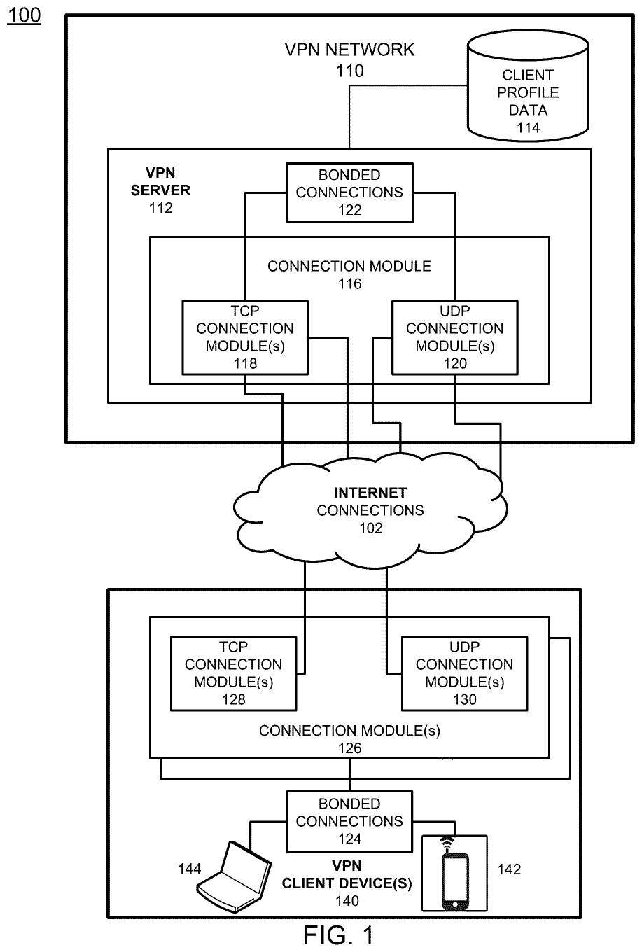

FIG. 1 illustrates an example data session network configuration according to example embodiments. Referring to FIG. 1, the configuration 100 may include a virtual private network (VPN) 110 which includes one or more VPN servers 112 and data storage, which in this case is used for storing at least client profile data 114 associated with one or more new or old client communication sessions. The term ‘VPN’ may represent one or more servers designated to perform the VPN functionality. The communication sessions may include multiple network channels, generally, UDP and TCP are used for such sessions, however, other protocols used across the Internet 102 may also be used, such as HTTPS. The channels may be bonded together to create a single virtual channel for communication as shown from the bonded connections module 122 for the VPN server 112 and the bonded connections module 124 of the client device 140. In general, the VPN 112 may include UDP module(s) 120 and a TCP module(s) 118 as part of a connection module 116 to manage the connection process and a bonded connections module 122 to manage the various channels and the bonding of information among the channels.

The client side may include one or more client devices 140 such as a smartphone 142, cell phone, tablet, laptop 144, etc. Any one of those individual devices may be the ‘client device’ 140 at any particular time for a particular session. The client side may have an installed agent software application that communicates with the cloud servers of the VPN network 110. The communications are established and maintained across the Internet 102. The client side may also have its own bonded connections module 124 which manages one or more TCP/UDP connections associated with TCP/UDP connection modules 128/130, each of which may have multiple modules to accommodate multiple session, as part of the connection module(s) 126 of the client side. The connection module 126 may be multiple modules which are used for multiple respective sessions with various end user devices 140.

In general, a transport connection is a connection between the VPN client and the VPN server over a particular network and/or Internet connection using a particular protocol, such as TCP, UDP, HTTPS, or another protocol. The established connection is used to send encapsulated and/or encrypted application packets between the client and the server. In one example embodiment, multiple transports connections are created for each session over the available networks and protocols. Conventionally, a VPN will create one transport connection over one network with one protocol per session. For example, given two networks to utilize, the data connection optimization application may create three transport connections (e.g., TCP, UDP, and HTTPS) over each network, for a total of six transport connections. Other combinations of connection types, numbers of connections, etc., may also be utilized.

A VPN may be used by any client device participating in a collaboration session (i.e., conference) with other client devices. One device among a plurality of devices may be using a VPN while others are not using any VPN. All of the devices may send data and receive data to and from an application server in a cloud network, however, one or more client devices may use a VPN server as an intermediate/third party device to assist with the data management of that particular client device. One strategy employed by a VPN may include channel management over a single session. For example, multiple channels may exist for a single client device and can be combined into a bonded channel (unique data is sent on more than one channel), a mirrored channel (the same data is sent on more than one channel) or a combination of both. The channel management activities may permit packets to be sent and received faster and/or with fewer errors depending on the strategy employed by the VPN server. The VPN server(s) may have an optimal Internet connection to the application servers in the cloud network, and may use certain fundamental routing strategies to optimize data traffic quality, the VPN could send video data first as prioritized data from certain client devices to the cloud servers as opposed to browser request data, e-mail data, and other types of Internet data. All of these data management strategies and others can be managed by a VPN specific application that is operating on the client devices while the conference or other collaboration application is being utilized. The VPN (client) application may be a background type of application that is not detectable by the user or other applications using Internet data services. The VPN server may also attempt to host its own conference assuming the VPN server offers an application that is managed locally by the VPN server so the client devices which are part of that VPN network can have the VPN server perform additional conference application functions.

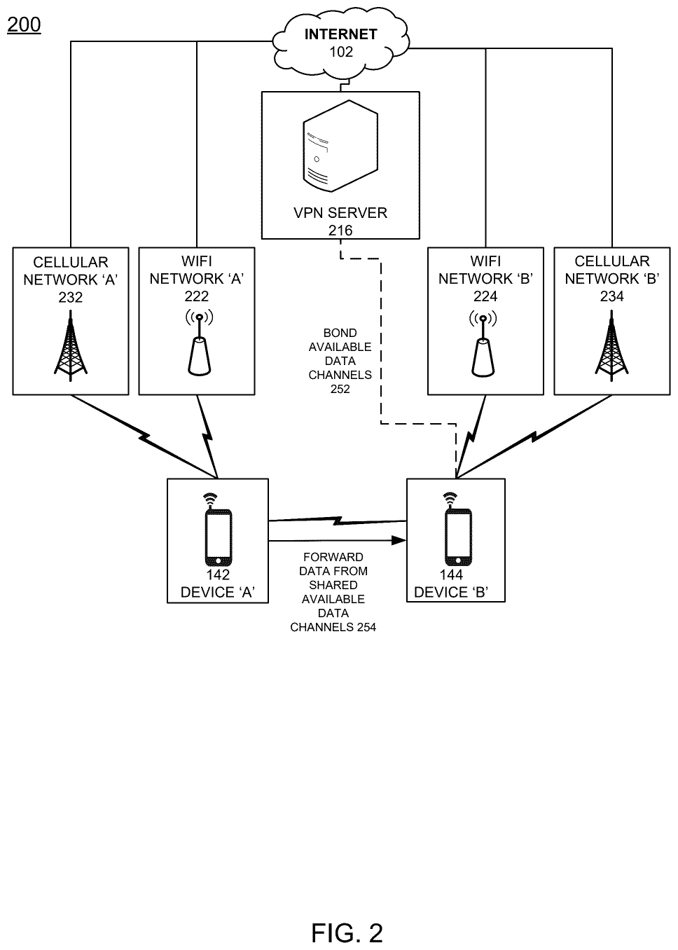

FIG. 2 illustrates an example of client devices sharing data across different Wi-Fi data networks according to example embodiments. Referring to FIG. 2, the network configuration 200 illustrates an example where client devices ‘A’ 142 and ‘B’ 144 are communicating with respective Wi-Fi networks ‘A’ 222 and ‘B’ 224. Both client devices may also have their own cellular data networks ‘A’ 232 and ‘B’ 234. In this example, device ‘B’ 144 may be using a cellular data connection and/or a Wi-Fi data connection to transfer data to and from the Internet. Device 144 may then discover another Wi-Fi connection through another user device 142. The communication between devices 142 and 144 may be a point to point, peer to peer (P2P), BLUETOOTH, and/or Wi-Fi communication protocol based connection directly between the two devices. Other communication protocols are contemplated, such as UWB, NFC, Li-Fi.

In one example, device 144 is communicating over a Wi-Fi network 224 and a cellular network 234. Device 142 is communicating over a different Wi-Fi network 222 and a same or different cellular network 232. Device 144 is using a VPN server 216 to manage its data communications. The VPN server 216 may receive and forward all data to and from the device 144 by encrypting, encapsulating and managing the data sent to and from device 144. The VPN server 216 may bond 252 together two or more channels of available data to and from the client device 144. The Wi-Fi network 224 may provide one channel of data and a second channel of data may be provided from cellular network 234. Device 144 then identifies device 142 and/or the device's Wi-Fi network 222 but may not have access to use the Wi-Fi network 222.

Continuing with the same example, device 144 may send a request to device 142 to receive data directly from device 142. Device 144 may be streaming data from a remote server and/or performing other data intensive operations and may be attempting to identify all possible data channels available. Once device 142 confirms the request and agrees to provide data sharing services by transmitting a response message directly to device 144 via a device-to-device communication protocol, then device 142 can receive instructions from device 144 to transmit data to and from the VPN server 216 over the Wi-Fi network 222 and the cellular network 232. The VPN server 216 can then bond the channel used from device 142, on behalf of device 144, over the Wi-Fi network 222, to the other channels used by device 144, such as a channel on Wi-Fi network 224 and/or a channel over cellular network 234, and essentially offer three channels bonded together. Additionally, if device 144 is soliciting device 142 for its Wi-Fi network data to be shared, it may also attempt to use its cellular network data 232, which could be combined with the other channels to essentially create a fourth channel when performing bonding by the VPN server 216.

The delivery of data to the device 144 may be provided by Wi-Fi network 224 and cellular network 234 for certain channels, however, the data shared by device 142 may be received from its respective Wi-Fi network 222 and cellular network 232 and sent directly via a device to device sharing operation between devices 142 and 144. The device 144 may simultaneously receive data packets from its respective networks while receiving data packets from device 142. The packets may be unique and may be combined into a single data stream, such as streaming data or other large data accumulations. When device 142 approves the data sharing request, then device 144 may transmit an instruction message that identifies the VPN server 216 as a destination to forward and receive data requests to and from device 142 on behalf of device 144. The VPN server 216 knows to continue transmitting packets to device 142 which are destined for device 144, and which may be part of a bonded stream. Device 142 will then forward 254 the packets directly to device 144 via a peer-to-peer data sharing protocol or via another data communication protocol or standard.

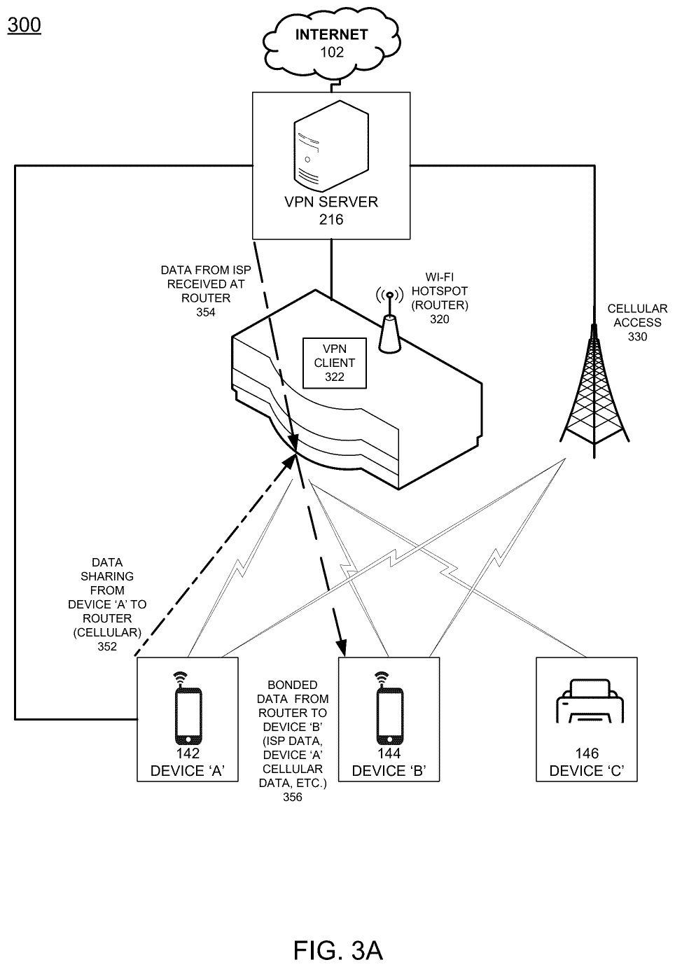

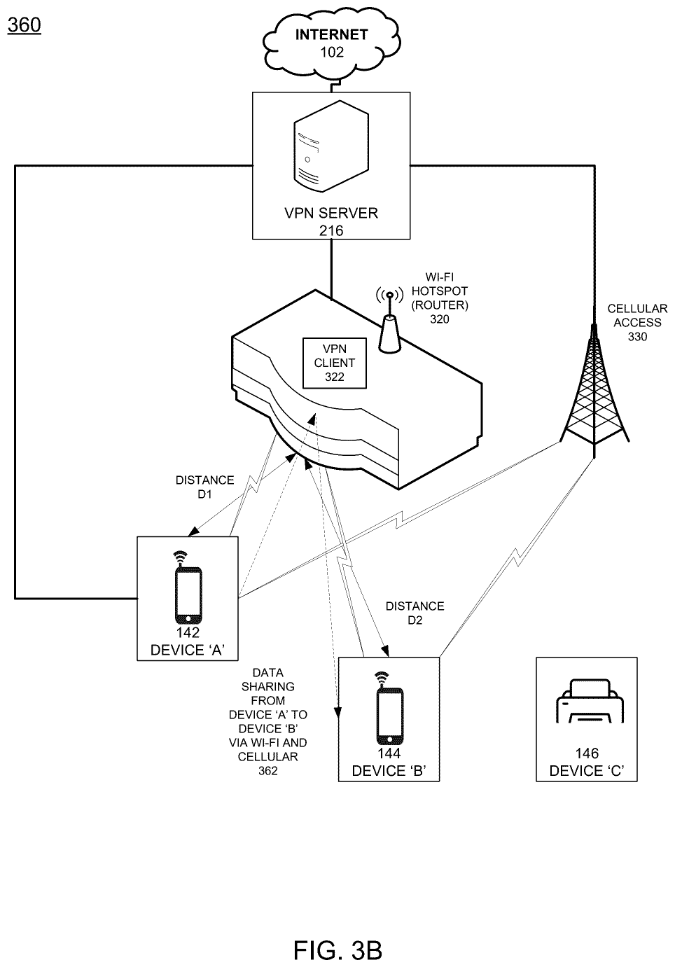

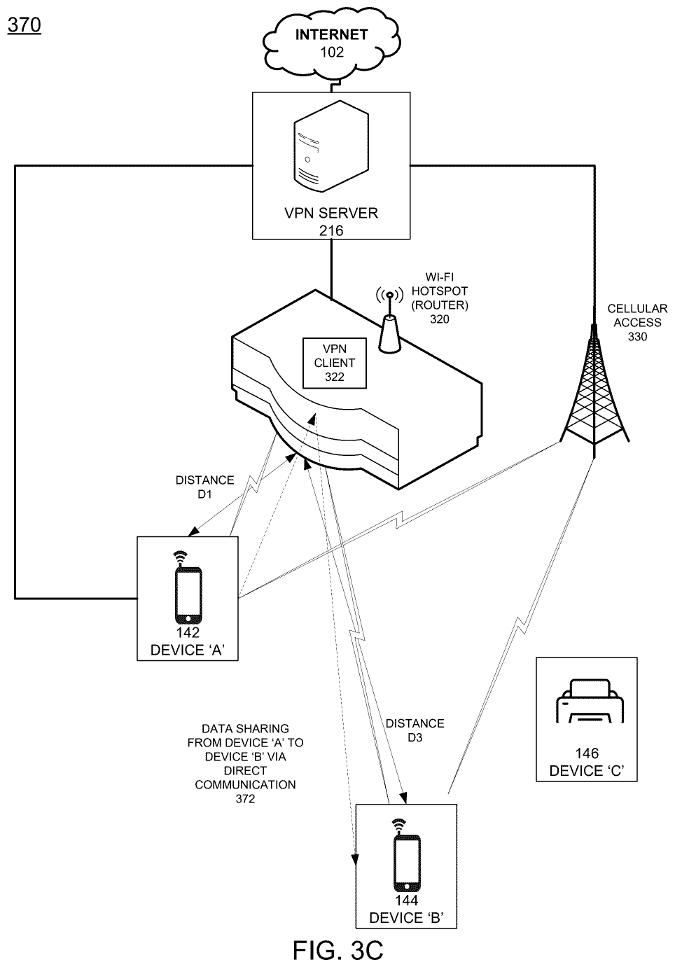

FIG. 3A illustrates an example of client devices sharing data across a router of a local area network according to example embodiments. Referring to FIG. 3A, the example network configuration 300 includes a VPN server 216 operating as a data management entity for one or more client devices 142/144/146. The network may include a local area network (LAN), such as a home or small office environment where an Internet service provider may offer a cable modem and/or fiber optic access to the Internet. The hotspot router 320 may be a Wi-Fi network connection that permits access to the Internet 102. One or more of the devices 142/144/146 may be operating with an application that recognizes and uses the VPN server 216 to route data to and from the Internet. The router 320 may have a plug-in application that is used to communicate with the VPN server 216 to identify itself as a data management entity that receives instructions from the VPN server 216 to bond data channels and/or add or remove channels which are available for the various devices.

In one example, the device 144 may have access to data from a cellular network 330, a Wi-Fi network managed by the router 320. In the event that device 144 is attempting to receive shared data from device 142 and borrow its data access paths to the Internet, device 144 may transfer a request for data to device 142 through the router 320. The confirmation message after the request is accepted by device 142 may include a notification regarding the VPN server 216, and an IP address and/or port(s) to use to request data during a data sharing operation. Device 142 may also provide port information for the router 320 to use when forwarding data received at the device 142 to the device 144. The router 320 may be able to forward data received directly by device 142 to device 144. For example, device 142 may be receiving data from cellular access point 330. The data may be sent by VPN server 216 and may be addressed to device 142 and also to device 144 via additional packet encapsulations identifying both device 142 and device 144 via destination address information in packets. Data forwarded via the router 320 from one device 142 to another 144 for the benefit of data sharing may be from an Internet service provider associated with the router 320, cellular data may be forwarded directly to the devices and reforwarded via the router, and/or by a combination of all data sources available. The data sources/channels may be bonded to form a bonded session of multiple communication channels (e.g., Wi-Fi, cellular, Wi-Fi and/or cellular of another device forwarded through the router, etc.).

One example process may include communicating, via a mobile device, with one or more of a Wi-Fi network and a cellular network, identifying, via the mobile device, another mobile device operating on another Wi-Fi network different from the Wi-Fi network, transmitting, via the mobile device, a request for data to the another mobile device and responsive to the request being approved by the another mobile device, receiving, via the mobile device, data from one or more of the Wi-Fi network and the cellular network and directly from the another mobile device.

The data received may be forwarded from a virtual private network (VPN) server to the Wi-Fi network, the cellular network and the another Wi-Fi network. The process may also include bonding, via the VPN server, a channel from the Wi-Fi network with a channel from the cellular network and a channel from the another Wi-Fi network, and transmitting, via the VPN server, a stream of packets received from a remote server over the channel from the Wi-Fi network, the channel from the cellular network, and the channel from the another Wi-Fi network as a bonded connection, and the stream of packets which identify the mobile device as the intended recipient.

The sharing of data may include an analysis of the types and number of data channels available to a particular device. For example, the router 320 and/or a device on the network may determine which devices have cellular data in addition to the available Wi-Fi data provided from the ISP. When a device inquires about additional data sources via an automated request sent responsive to a trigger (e.g., large data usage, etc.), the router 320 may be able to identify a candidate device that is capable of sharing data, such as its own Wi-Fi data and/or cellular data. The data may be received by the router directly from the ISP and/or from the device willing to share data, such as from a cellular connection. The data is then routed to the device receiving the benefit of the shared data as a bonded channel or separately in another channel. The VPN server 216 may be instructing the router 320 how to distribute the data which may be encapsulated to include the final destination of the device receiving the shared data. The router 320 may be a VPN client 322 and may create a VPN tunnel to the Internet that connects to the VPN server 216. The router 320 can provide connections from the other devices on the Wi-Fi network and send all the data to one device, such as device 144 which is receiving the shared data 352.

In one example, the router 320 may forward received data from the Internet, forward received data from a mobile device (e.g., cellular data), perform channel bonding by organizing packets, consuming available data, encrypting, unencrypting, encapsulating packets, etc. For example, data packets received at the router 320 from a remote streaming server may be partially received via an Internet connection associated with the router ISP, and also partially received from a cellular download at a mobile device, which is then forwarded to the router 320 to create a bonding data stream sent from the router 320 to the intended end point mobile device. The router 320 can encapsulate, encrypt and bond the packets in a data stream for delivery to the recipient mobile device. Unlike traditional Wi-Fi routers, which tend to act as endpoints for packet forwarding, the router 320 may be receiving data from devices on its network which also act as endpoints. In one example of FIG. 3A, if the device B 144 is receiving data from a sharing device A 142, then the data stream 356 received at device B 144 may include data 352 sent to the router 320 from device 142, such as cellular data received at device 142 and forwarded to the router, data 354 from the Internet and forwarded from VPN server 216 received at router 320. The data stream 356 sent to device 144 may be a bonded data session of multiple bonded channels. The VPN client 322 installed on the router 320 enables the data management services of a VPN server to be handled by the router for more efficient data sharing efforts performed on a smaller or local area network (LAN).

FIG. 3B illustrates an example of client devices sharing data across a router of a local area network according to example embodiments. Referring to FIG. 3B, the example 360 includes a first configuration where device 142 is a first distance D1 from the router 320, and device 144 is a second distance D2 from the router 320. In this example, both devices are close enough to the router 320 that data communication signals are received without crossing certain quality thresholds, such as jitter, latency, packet loss, and delay. The device 144 may use the shared data 362 received from device 142 using the router 320 as a data relay device. The data sharing is managed by the VPN server 216 and/or the VPN client 322 on the router. The device 144 may receive all data channels available to it and also the data channels available to device 142. The Wi-Fi signal strength of the router 320 may be used as a measure of how the data should be routed. When the signal strength between the devices is stronger and more reliable than the connection to the router for any one of the devices, then the strength measured in dB and/or time, latency, jitter, packet loss, etc. may be used as a basis for deciding whether to use the router 320 or whether to use direct data communications between the devices.

FIG. 3C illustrates an example of client devices sharing data directly in a local area network according to example embodiments. Referring to FIG. 3C, the distance D3 between the device 144 and the router may be too far to effectively receive data from the router at device 144. In this case, the device 144 may still use its cellular data to send and receive data. In order to receive shared data from device 142, the device 144 may still receive data from device 142, however, the data may be sent directly from the device 142 via a P2P communication protocol and/or BLUETOOTH or other direct communication protocols used by client devices. As the device 144 moves away from the router, the data signals may become less reliable when transmitting and receiving to and from the router 320. The client application on the client devices may instead switch to a direct communication between client devices so device 144 could still effectively receive data from device 142, and the data provided by device 142 was received from the router 320 at the device 142 and/or from the cellular connection available to device 142.

In one example, a main connection to the router 320 may fail, and the router may then initiate an alternative data use scenario where shared cellular data from one or more devices in communication with the router is shared with one or more other devices to maintain a client device online connection. For instance, one example, the ISP connection or WAN connection providing the router 320 with data may fail or slow down to a data rate that is below a threshold data rate. The data rate of the router may not be able to support a target data rate for the client devices 142, 144, 146, etc., so the router 320 may initiate a channel bond operation with one or more cellular data channels which are used to forward data to and from the router 320 by the one or more devices and to and from a cellular access point 330. The router 320 may forward the cellular originated data to the one or more devices which are attempting to transmit and receive data based on a previously negotiated share function. When the main connection is slow, the channels may be bonded to include the main Internet channel coupled with the cellular data channel. The combination of bonded channels may provide an optimal/target data rate to any of the mobile devices.

In one example, the router 320 may be attempting to identify which mobile devices require the data service. One device may be using an application that is identified by a list of applications requiring priority data use. Another option may be for the router to identify more important data being used by a client device (i.e., streaming, real time traffic, etc.) and send only that priority traffic via the cellular connections available via other mobile devices while keeping traffic from other devices on the main WAN connection, which in this case may have slowed down. The bonding may combine the channels, however, only certain application data of certain devices may be eligible to use a particular channel (cellular) during the bonded channel session, while other applications may not be eligible to use the particular channel (cellular) and may be limited to the original data channel (WAN connection).

One example may include establishing a packet mirroring operation while multiple channels are bonded. During a bonded channel session, packets may be duplicated and sent over multiple channels simultaneously to ensure their delivery. Certain priority data may be mirrored on the WAN based channel and one or more cellular based channels. Such data may be deemed important and may be added to one or more cellular connections if the main WAN connection is exhibiting poor performance, packet loss, high latency, or other data metric loss, etc.

Certain restrictions may be imposed on cellular use and distribution by the router 320. For example, a cellular channel may initiate a data tracking function that identifies the total amount of time a cellular channel is used, a total amount of data consumed by a cellular channel and/or other metrics intended to not overuse a cellular channel. For instance, data usage by a cellular device may cause a temperature increase and/or a loss of battery power. The router 320 may be cognizant of the mobile device's battery status and may stop using cellular data from a client device when battery drops below a certain threshold value of power (e.g., 25%). Another option may be to stop using cellular data when a certain amount of data is consumed, such as 1 GB. Yet another option may be to stop use of cellular data from certain devices based on the device's cellular signal strength and/or data performance (e.g., latency, jitter, packet loss).

Another option may include deciding to use or not use cellular from various devices based on the cellular carrier. For instance, the router 320 may be more likely to use cellular data provided by various devices when their carrier networks are different since this approach would increase the likelihood that data use is distributed between local carriers as opposed to saturating a single cellular carrier by using multiple channels from a same carrier. Another approach may be to limit the number of channels from a common carrier by a single router to two channels and requiring any third channel to be from a different carrier (e.g., Verizon, T-Mobile, AT&T). In one example, if any of the mobile devices 142/144 has multiple SIM cards, the router may select one particular carrier at a time while omitting other carriers based on a list of carriers being used by the router.

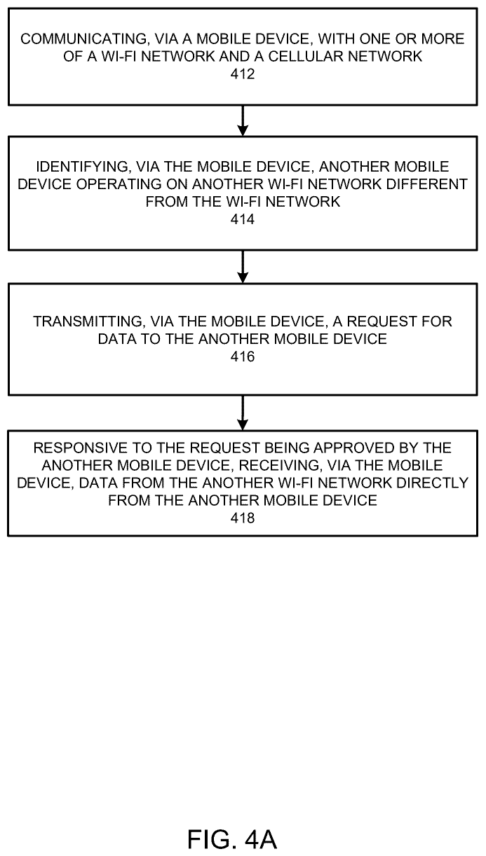

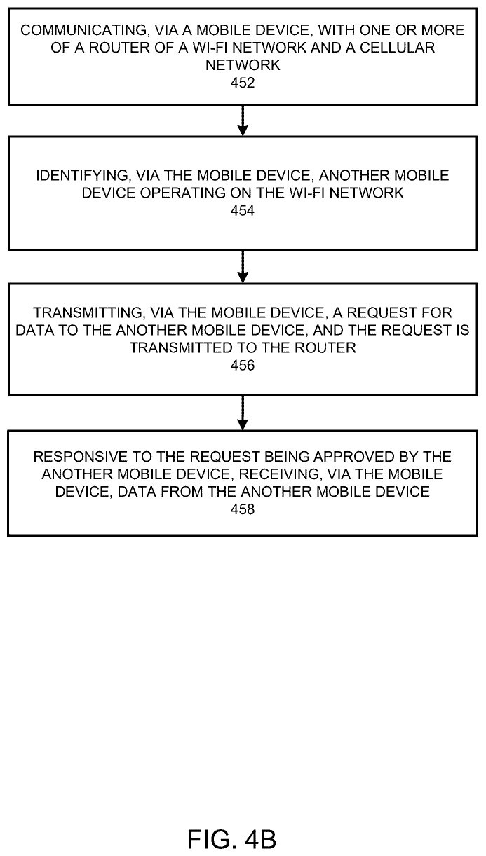

FIG. 4A is a process according to example embodiments. Referring to FIG. 4A, the process may include communicating, via a mobile device, with a data network or one or more of a Wi-Fi network and a cellular network 412, identifying, via the mobile device, another mobile device operating on another data network and/or a Wi-Fi network different from the Wi-Fi network 414, transmitting, via the mobile device, a request for data to the another mobile device 416, and responsive to the request being approved by the another mobile device, receiving, via the mobile device, data from the another Wi-Fi network directly from the another mobile device 418.

The data received may be forwarded from a virtual private network (VPN) server to the another Wi-Fi network. The process may also include bonding, via the VPN server, a channel from the Wi-Fi network with a channel from the cellular network and a channel from the another Wi-Fi network, and transmitting, via the VPN server, a stream of packets received from a remote server over the channel from the Wi-Fi network, the channel from the cellular network and the channel from the another Wi-Fi network as a bonded connection, wherein the stream of packets identify the mobile device as the intended recipient.

The process may also include responsive to receiving confirmation the request was approved, forwarding, via the mobile device, an IP address identifying a virtual private network (VPN) server to the another mobile device, receiving, via the mobile device, first data from a bonded data session comprising a channel from the cellular network and a channel from the Wi-Fi network, and after the request for data is approved, receiving, via the mobile device, second data from another bonded session comprising the channel from the cellular network, the channel from the Wi-Fi network and one or more channels provided by the another mobile device.

FIG. 4B is a process according to example embodiments. Referring to FIG. 4B, the process may include communicating, via a mobile device, with one or more of a router of a Wi-Fi network and a cellular network 452, identifying, via the mobile device, another mobile device operating on the Wi-Fi network 454, transmitting, via the mobile device, a request for data to the another mobile device, wherein the request is transmitted to the router 456, and responsive to the request being approved by the another mobile device, receiving, via the mobile device, data from the another mobile device 458.

The data received may be forwarded from the router. The router may receive the data from a virtual private network (VPN) server. The data may be provided from the cellular network. The process may also include identifying a strength of a signal between the mobile device and the router is below a threshold signal strength, receiving, via the mobile device, the data directly from the another mobile device. The router is operating a virtual private network (VPN) client application that causes the data to be received at the router from a VPN server. The process may also include bonding a channel of the Wi-Fi network with a channel of the cellular network and another channel provided by the another mobile device, and providing the data to the mobile device via the bonded channel.

The operations of a method or algorithm described in connection with the embodiments disclosed herein may be embodied directly in hardware, in a computer program executed by a processor, or in a combination of the two. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

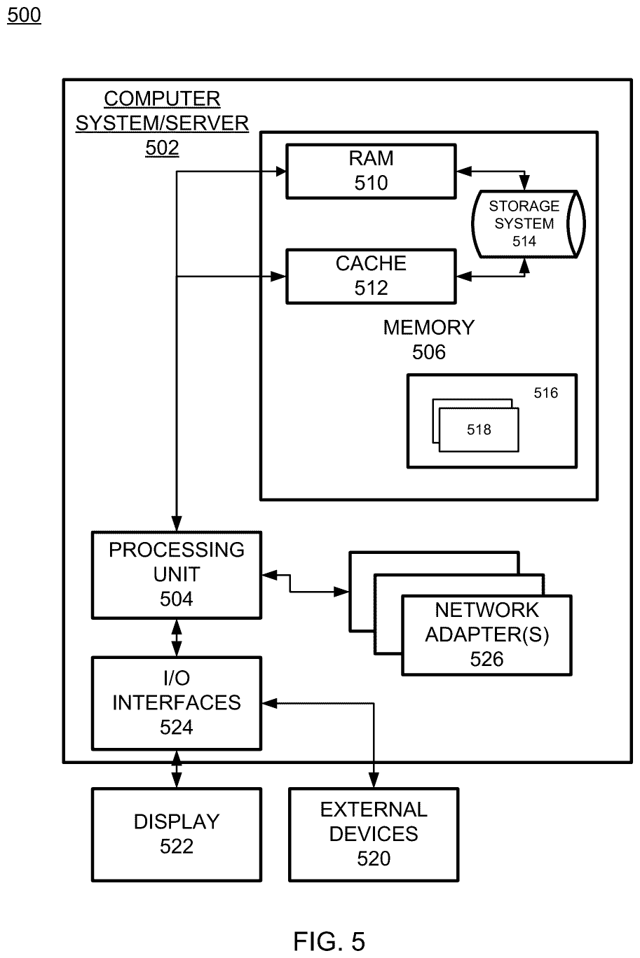

FIG. 5 illustrates an example network entity device configured to store instructions, software, and corresponding hardware for executing the same according to example embodiments. FIG. 5 is not intended to suggest any limitation as to the scope of use or functionality of embodiments of the application described herein. Regardless, the computing node 500 is capable of being implemented and/or performing any of the functionality set forth hereinabove.

In computing node 500 there is a computer system/server 502, which is operational with numerous other general purpose or special purpose computing system environments or configurations. Examples of well-known computing systems, environments, and/or configurations that may be suitable for use with computer system/server 502 include, but are not limited to, personal computer systems, server computer systems, thin clients, rich clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 502 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 502 may be practiced in distributed cloud computing environments where tasks are performed by remote processing devices that are linked through a communications network. In a distributed cloud computing environment, program modules may be located in both local and remote computer system storage media including memory storage devices.

As displayed in FIG. 5, computer system/server 502 in cloud computing node 500 is displayed in the form of a general-purpose computing device. The components of computer system/server 502 may include, but are not limited to, one or more processors or processing units 504, a system memory 506, and a bus that couples various system components including system memory 506 to processor 504.

The bus represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 502 typically includes a variety of computer system readable media. Such media may be any available media that is accessible by computer system/server 502, and it includes both volatile and non-volatile media, removable and non-removable media. System memory 506, in one embodiment, implements the flow diagrams of the other figures. The system memory 506 can include computer system readable media in the form of volatile memory, such as random-access memory (RAM) 510 and/or cache memory 512. Computer system/server 502 may further include other removable/non-removable, volatile/non-volatile computer system storage media. By way of example only, storage system 514 can be provided for reading from and writing to a non-removable, non-volatile magnetic media (not displayed and typically called a “hard drive”). Although not displayed, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to the bus by one or more data media interfaces. As will be further depicted and described below, memory 506 may include at least one program product having a set (e.g., at least one) of program modules that are configured to carry out the functions of various embodiments of the application.

Program/utility 516, having a set (at least one) of program modules 518, may be stored in memory 506 by way of example, and not limitation, as well as an operating system, one or more application programs, other program modules, and program data. Each of the operating system, one or more application programs, other program modules, and program data or some combination thereof, may include an implementation of a networking environment. Program modules 518 generally carry out the functions and/or methodologies of various embodiments of the application as described herein.

As will be appreciated by one skilled in the art, aspects of the present application may be embodied as a system, method, or computer program product. Accordingly, aspects of the present application may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present application may take the form of a computer program product embodied in one or more computer readable medium(s) having computer readable program code embodied thereon.

Computer system/server 502 may also communicate with one or more external devices 520 such as a keyboard, a pointing device, a display 522, etc.; one or more devices that enable a user to interact with computer system/server 502; and/or any devices (e.g., network card, modem, etc.) that enable computer system/server 502 to communicate with one or more other computing devices. Such communication can occur via I/O interfaces 524. Still yet, computer system/server 502 can communicate with one or more networks such as a local area network (LAN), a general wide area network (WAN), and/or a public network (e.g., the Internet) via network adapter(s) 526. As depicted, network adapter(s) 526 communicates with the other components of computer system/server 502 via a bus. It should be understood that although not displayed, other hardware and/or software components could be used in conjunction with computer system/server 502. Examples include, but are not limited to: microcode, device drivers, redundant processing units, external disk drive arrays, RAID systems, tape drives, and data archival storage systems, etc.

One skilled in the art will appreciate that a “system” could be embodied as a personal computer, a server, a console, a personal digital assistant (PDA), a cell phone, a tablet computing device, a smartphone or any other suitable computing device, or combination of devices. Presenting the above-described functions as being performed by a “system” is not intended to limit the scope of the present application in any way but is intended to provide one example of many embodiments. Indeed, methods, systems and apparatuses disclosed herein may be implemented in localized and distributed forms consistent with computing technology.

It should be noted that some of the system features described in this specification have been presented as modules, in order to more particularly emphasize their implementation independence. For example, a module may be implemented as a hardware circuit comprising custom very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together but may comprise disparate instructions stored in different locations which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction, or many instructions, and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above may be practiced with steps in a different order, and/or with hardware elements in configurations that are different than those which are disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only and the scope of the application is to be defined solely by the appended claims when considered with a full range of equivalents and modifications (e.g., protocols, hardware devices, software platforms etc.) thereto.

What is claimed is:

1. A method comprising:
communicating, via a mobile device, with a router of a Wi-Fi network and a base station of a cellular network;
identifying, via the mobile device, another mobile device operating on the Wi-Fi network;
transmitting, via the mobile device, a request for data to the another mobile device, wherein the request is transmitted to the router; and
responsive to the request being approved by the another mobile device, receiving, via the mobile device, data from the another mobile device.

2. The method of claim 1, wherein the data received is forwarded from the router.

3. The method of claim 1, wherein the router receives the data from a virtual private network (VPN) server.

4. The method of claim 1, wherein the data is provided from the cellular network.

5. The method of claim 1, comprising
identifying a strength of a signal between the mobile device and the router is below a threshold signal strength; and
receiving, via the mobile device, the data directly from the another mobile device.

6. The method of claim 1, wherein the router is operating a virtual private network (VPN) client application that causes the data to be received at the router from a VPN server.

7. The method of claim 1, comprising
bonding a channel of the Wi-Fi network with a channel of the cellular network and another channel provided by the another mobile device; and
providing the data to the mobile device via the bonded channel.

8. A system comprising:
a mobile device configured to
communicate with a router of a Wi-Fi network and a cellular network;
identify another mobile device operating on the Wi-Fi network;
transmit a request for data to the another mobile device, wherein the request is transmitted to the router; and
responsive to the request being approved by the another mobile device, receive data from the another mobile device.

9. The system of claim 8, wherein the data received is forwarded from the router.

10. The system of claim 8, wherein the router receives the data from a virtual private network (VPN) server.

11. The system of claim 8, wherein the data is provided from the cellular network.

12. The system of claim 8, wherein the mobile device is further configured to
identify a strength of a signal between the mobile device and the router is below a threshold signal strength; and
receive the data directly from the another mobile device.

13. The system of claim 8, wherein the router is operating a virtual private network (VPN) client application that causes the data to be received at the router from a VPN server.

14. The system of claim 8, wherein the router is configured to
bond a channel of the Wi-Fi network with a channel of the cellular network and another channel provided by the another mobile device; and
provide the data to the mobile device via the bonded channel.

15. A non-transitory computer readable storage medium configured to store instructions that when executed cause a processor to perform:
communicating, via a mobile device, with a router of a Wi-Fi network and a base station of a cellular network;
identifying, via the mobile device, another mobile device operating on the Wi-Fi network;
transmitting, via the mobile device, a request for data to the another mobile device, wherein the request is transmitted to the router; and
responsive to the request being approved by the another mobile device, receiving, via the mobile device, data from the another mobile device.

16. The non-transitory computer readable storage medium of claim 15, wherein the data received is forwarded from the router.

17. The non-transitory computer readable storage medium of claim 15, wherein the router receives the data from a virtual private network (VPN) server.

18. The non-transitory computer readable storage medium of claim 15, wherein the data is provided from the cellular network.

19. The non-transitory computer readable storage medium of claim 15, wherein the processor is further configured to perform:
identifying a strength of a signal between the mobile device and the router is below a threshold signal strength; and
receiving, via the mobile device, the data directly from the another mobile device.

20. The non-transitory computer readable storage medium of claim 15, wherein the router is operating a virtual private network (VPN) client application that causes the data to be received at the router from a VPN server.
